(19) United States
(12) Patent Application Publication
(10) Pub. No.: US 2025/0180082 A1
(43) Pub. Date: Jun. 5, 2025

(54) ELECTROMECHANICAL DRUM BRAKE

(71) Applicant: Robert Bosch GmbH, Stuttgart (DE)

(72) Inventors: Michael Janhsen, Stuttgart (DE); Simon Peter, Weil Der Stadt (DE)

(21) Appl. No.: 18/956,082

(22) Filed: Nov. 22, 2024

(30) Foreign Application Priority Data
Dec. 5, 2023 (DE) 10 2023 212 244.8

(51) Int. Cl. F16D 51/22; F16D 65/22; F16D 121/24; F16D 125/24

(52) U.S. Cl. CPC F16D 51/22; F16D 65/22; F16D 2121/24; F16D 2125/24

(57) ABSTRACT

An electromechanical drum brake for a motor vehicle. The electromechanical drum brake includes a drum, in which brake shoes are disposed, and an adjusting device, which is disposed between the brake shoes and driven by a drive unit, using which the brake shoes can be spread apart for braking. The adjusting device includes a rack driven by the drive unit, is floatingly mounted between the brake shoes and is in engagement with a coupling gear that acts on a first brake shoe via a push rod connected to it. An actuating rack which acts on a second brake shoe is in engagement with the coupling gear on a side of the coupling gear opposite to the rack, and the coupling gear can move freely on the rack between the brake shoes so that force differences that occur between the brake shoes can be compensated by rotating the coupling gear.

### CROSS REFERENCE

The present application claims the benefit under 35 U.S.C. § 119 of German Patent Application No. DE 10 2023 212 244.8 filed on Dec. 5, 2023, which is expressly incorporated herein by reference in its entirety.

### FIELD

The present invention relates to an electromechanical drum brake for a motor vehicle. The present invention also relates to a motor vehicle comprising such an electromechanical drum brake.

### BACKGROUND INFORMATION

Drum brakes with various types of actuation are available in today's vehicles. In passenger cars, the drum brakes are typically actuated hydraulically. Hydraulic pressure is built up in a double piston that is thus spread apart, as a result of which a force acts on each brake shoe of the drum brake. The design with movable pistons on both sides, which are coupled via the fluid, ensures that the forces on both brake shoes are always the same. For future passenger cars, hydraulic actuation could be replaced by an electromechanical actuation. For mechanical actuation, there is a wide variety of variants.

Drum brakes in the truck sector are typically actuated pneumatically, in which case the pneumatic piston is disposed outside the brake and therefore the actuation itself is mechanical. In such designs, actuation with S-Cam and wedge has become the norm. These designs typically have same-path actuation of the brake shoes without force compensation. Mechanical actuation generally involves a considerable amount of mechanical effort to ensure actuation with force compensation.

The reason for this is that the low-friction displacement of individual parts of the actuators typically has to be ensured with additional mechanical elements and cannot be achieved via pressure compensation in the hydraulic fluid as is the case in hydraulic brakes.

U.S. Pat. No. 10,001,186 B2 describes a drum brake assembly with a drum in which two brake shoes are disposed. At one end of the brake shoes, said brake shoes are pivotably connected to one another. An S-shaped cam, which spreads the brake shoes apart by rotating so that they engage with the drum and a braking effect is achieved, is disposed between a second end of the brake shoes. A shaft of the cam is driven via an electric motor. The electric motor can be connected to the shaft via a planetary gear, a worm gear or directly.

An object of the present invention is to provide an electromechanical drum brake which has an improved braking effect and requires less effort in terms of design.

The object may be achieved by an electromechanical drum brake having certain features of the present invention. Preferred example embodiments of the present invention are disclosed herein.

### SUMMARY

The present invention provides an electromechanical drum brake for a motor vehicle. According to an example embodiment of the present invention, the electromechanical drum brake comprises a drum, in which brake shoes are disposed, and an adjusting device, which is disposed between the brake shoes and driven by a drive unit, by means of which the brake shoes can be spread apart for braking. The adjusting device comprises a rack which is driven by the drive unit, is floatingly mounted between the brake shoes and is in engagement with a coupling gear that acts on a first brake shoe via a push rod connected to it. An actuating rack which acts on a second brake shoe is in engagement with the coupling gear on a side of the coupling gear opposite to the rack, and the coupling gear can move freely on the rack between the brake shoes so that force differences that occur between the brake shoes can be compensated by rotating the coupling gear.

The adjusting device is a device with which a force can be applied to the brake shoes so that they are placed against a drum. The adjusting device is preferably disposed at an upper end of the brake shoes. The drive unit preferably comprises an electric motor. A floating mount is understood to mean that the rack is not fixed in relation to the drum, but can move toward the drum via a bearing, for example. The rack can move along its longitudinal extension so that it moves between the brake shoes. The coupling gear, too, can move freely between the brake shoes.

The coupling gear is moved accordingly between the brake shoes, so that a balance of forces is achieved between the brake shoes. This makes it possible to compensate tolerances and eccentricity within the drum brake. The brake shoes can thus be optimally placed against the drum so that they can develop their self-reinforcing properties. This improves the braking effect of the drum brake. Balancing the forces applied to the brake shoes significantly reduces the position forces on the adjusting device are. This enables mounting, the mechanical strength of which is significantly reduced and which can have a simpler design. The design effort for such a drum brake can thus be reduced.

The coupling gear not only makes it possible to push the brake shoes apart, but, by actuating the rack accordingly, it is also possible to apply a tensile force to the brake shoes so that they can be released from the drum after a braking operation. This makes it possible to prevent the brake shoes from grinding after a braking operation. It is also possible to release sticking brake shoes, which can occur with drum brakes after long periods of inactivity.

In a preferred example embodiment of the present invention, the coupling gear is configured as a multi-gear, and the rack and the actuating rack are in engagement with different gear rings of the multi-gear so that a transmission ratio is created. The gear rings can therefore be configured according to the desired requirements. This increases flexibility for the drive of the actuating rack and the drive of the coupling gear.

In another preferred example embodiment of the present invention, the actuating rack is fork-shaped in the region of the coupling gear and each portion of the fork-shaped actuating rack is in engagement with a gear ring having the same number of teeth. A fork-shaped configuration of the actuating rack is understood to mean that the actuating rack is split along its longitudinal extension and the two portions of the actuating rack are spaced apart from one another. The fork-shaped actuating rack engages the coupling gear symmetrically. This prevents a torque being applied to the coupling gear during a braking operation. Because of the fork-shaped engagement of the actuating rack on the coupling gear, there is no need for additional mounting of the coupling gear. This simplifies the structural design of an electromechanical drum brake configured in this way.

The push rod preferably has a joint which permits movements of the push rod orthogonal to an axis of rotation of the coupling gear and orthogonal to longitudinal extension of the push rod. The push rod is therefore not rigidly disposed on the coupling gear. Since the brake shoes move in the drum during a braking operation, this possible movement is ensured by such a joint. The brake shoes can therefore assume an optimal position in the drum in order to improve the braking effect.

In an advantageous further development of the present invention, the drive unit is driven in a torque-controlled manner. Controlling the drive unit to a torque instead of a path makes it possible to ensure that a predefined braking force is continuously applied to the brake shoes. This also compensates wear of the brake pads disposed on the brake shoes.

The rack is advantageously driven via a drive pinion that has a smaller diameter than the coupling gear. The use of a small drive pinion enables the use of a smaller electric motor that also has a lower weight. This makes it possible to reduce the overall weight and also the size of the electromechanical brake.

In another advantageous example embodiment of the present invention, the actuating rack is configured to apply a force to the second brake shoe at the level of an axis of the coupling gear. Because of the corresponding configuration of the actuating rack, the force of the push rod and the actuating rack are at the same level. This prevents a torque being applied to the coupling gear. Such a torque would lead to an uneven distribution of force on the brake shoes. The corresponding configuration improves the balance of forces between the brake shoes.

The present invention also specifies a motor vehicle comprising such an electromechanical drum brake according to the present invention. Such a motor vehicle has the above-described advantages and functions.

Embodiment examples of the present invention are shown in the figures and explained in more detail in the following description.

### BRIEF DESCRIPTION OF THE DRAWINGS

FIG. 1 shows an electromechanical drum brake according to a first embodiment example of the present invention.

FIG. 2 shows an illustration of the drum according to an embodiment example of the present invention.

FIG. 3 shows an illustration of an adjusting device according to an embodiment example of the present invention.

FIG. 4 shows a perspective view of the adjusting device according to FIG. 3.

### DETAILED DESCRIPTION OF EXAMPLE EMBODIMENTS

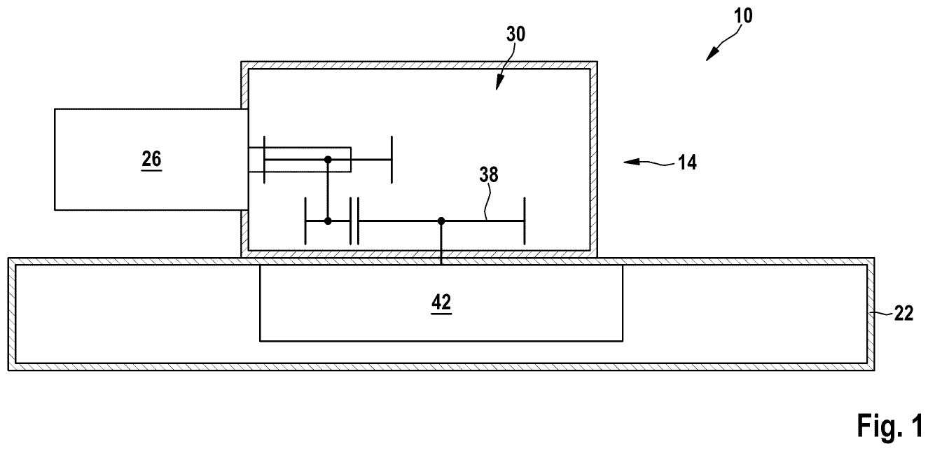

FIG. 1 shows an electromechanical drum brake 10 according to a first embodiment example of the present invention. The electromechanical drum brake 10 comprises a drive unit 14 which is disposed on a rear wall 18 of a drum 22. The drive unit 14 comprises an electric motor 26 which drives a gear unit 30. The gear unit 30 is driven on the input side by a worm 34 that comes off the electric motor 26. The gear unit 30 is formed by a plurality of spur gears 38. On the output side, the gear unit 30 drives an adjusting device 42 of the drum 22.

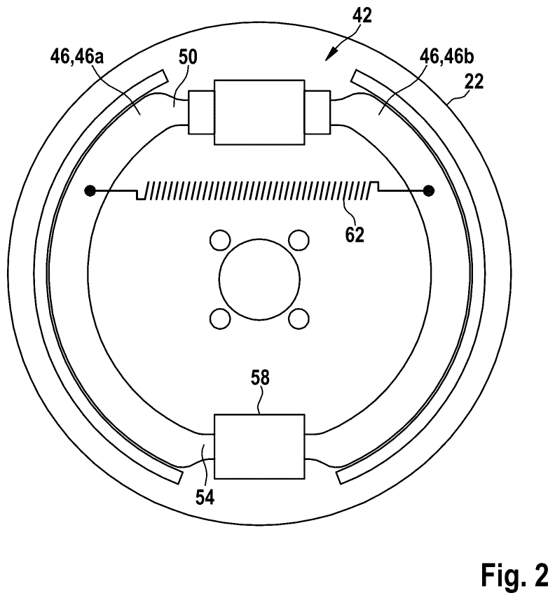

FIG. 2 shows an illustration of the drum 22 according to an embodiment example of the present invention. The adjusting device 42 already shown in FIG. 1 is disposed in the drum 22. Also disposed in the drum 22 are brake shoes 46, which cooperate with the drum 22 for braking. The adjusting device 42 is disposed at an upper end 50 of the brake shoes 46. For braking, the adjusting device 42 acts on the brake shoes 46 so that they are spread apart and pressed against the drum 22. A support element 58, via which the two brake shoes 46 are connected, is disposed at a lower end 54 of brake shoes 46. Between the brake shoes 46 there is also a spring 62, via which the brake shoes 46 can be released from the drum 22 after a braking operation.

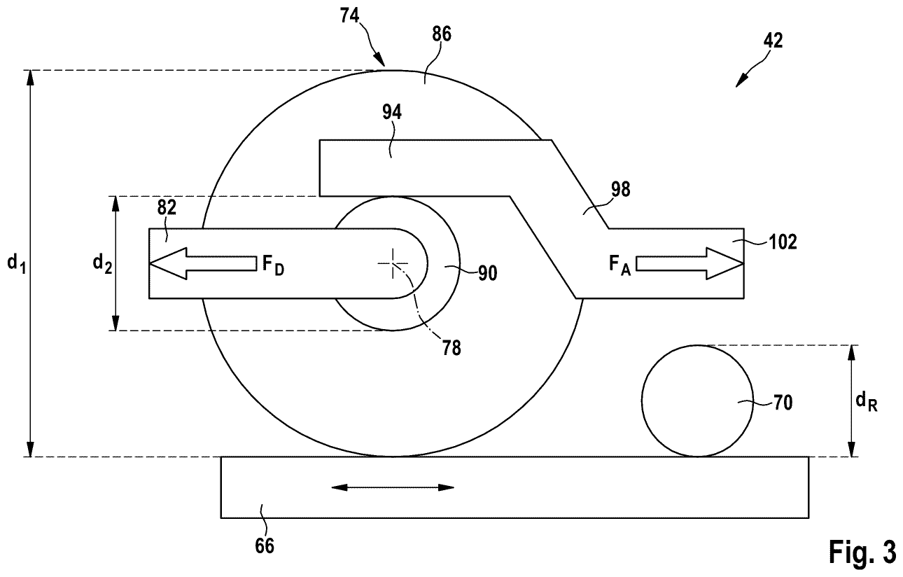

FIG. 3 shows an illustration of an adjusting device 42 according to an embodiment example of the present invention. The adjusting device 42 includes a floatingly mounted rack 66 which is in engagement with a drive pinion 70. The drive pinion 70 is driven via the drive unit 14. The rack 66 can be moved between the brake shoes 46 by rotating the drive pinion 70. The adjusting device 42 also comprises a coupling gear 74 that is in meshing engagement with the rack 66. A push rod 82 is disposed on an axis 78 of the coupling gear 74 and acts on a first brake shoe 46a of the drum brake 10.

In the embodiment example shown here, the coupling gear 74 is configured as a multi-gear, wherein a first gear ring 86, which is in engagement with the rack 66, has a greater diameter d₁ than a diameter d2 of a second gear ring 90. The different diameters create a transmission ratio. In the embodiment example shown here, a diameter dr of the drive pinion 70 is less than the diameter d₁ of the first gear ring 86. This makes it possible to reduce the size and thus the weight of the electric motor 26.

The adjusting device 42 further comprises an actuating rack 94 which is in engagement with the second gear ring 90 on a side of the coupling gear 74 opposite to the rack 66. The actuating rack 94 comprises a bending section 98, which is configured such that a section 102 acting on the second brake shoe 46b applies a force FA to the second brake shoe 46b at the level of the axis 78. This prevents a torque being applied to the second gear ring 90. The force FA of the actuating rack 94 is at the same level as a force FD of the push rod 82. This therefore makes it possible to improve balancing of the forces FA, ED between brake shoes 46.

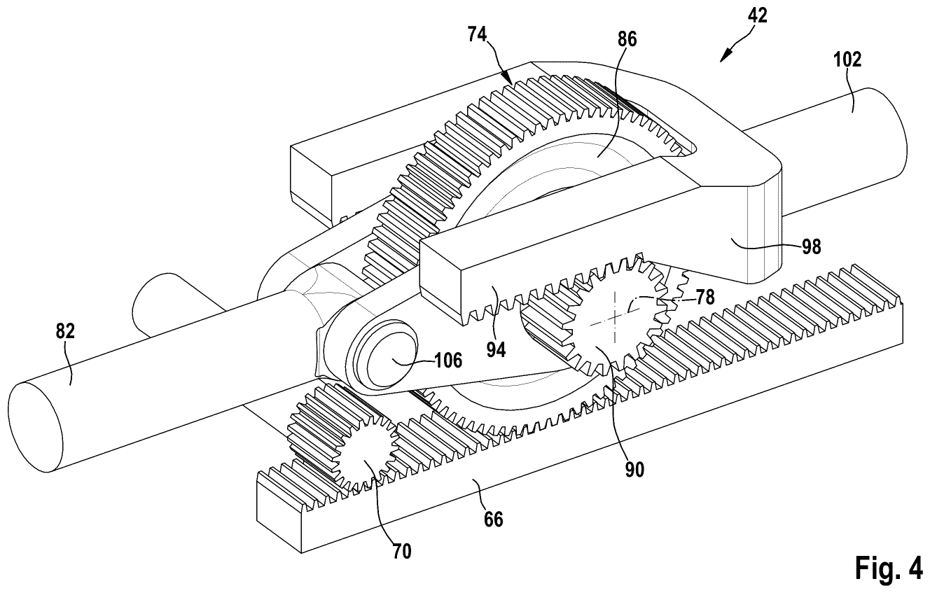

FIG. 4 shows a perspective view of the adjusting device 42 according to FIG. 3. It can be seen here that the actuating rack 94 is fork-shaped in the region of the coupling gear 74. The actuating rack 74 engages in the second gear ring 90 on both sides of the first gear ring 86. The second gear ring 90 is accordingly disposed on both sides of the first gear ring 86. This prevents a torque being applied to the coupling gear 74. In the embodiment example shown here, the push rod 82 has a joint 106 which permits movement orthogonal to the axis 78 of the coupling gear 74 and an extension of the push rod 82. Movements of the brake shoe 46 can be compensated via this joint 106.

What is claimed is:

1. An electromechanical drum brake for a motor vehicle, comprising:
a drum, in which brake shoes are disposed; and
an adjusting device, which is disposed between the brake shoes and driven by a drive unit using which the brake shoes can be spread apart for braking, the adjusting device including a rack which is driven by the drive unit, is floatingly mounted between the brake shoes, and is in engagement with a coupling gear that acts on a first brake shoe of the brake shoes via a push rod connected to it, wherein an actuating rack which acts on a second brake shoe of the brake shoes is in engagement with the coupling gear on a side of the coupling gear opposite to the rack, and the coupling gear can move freely on the rack between the brake shoes so that force differences that occur between the brake shoes can be compensated by rotating the coupling gear.

2. The electromechanical drum brake according to claim 1, wherein the coupling gear is a multi-gear and the rack and the actuating rack are in engagement with different gear rings of the multi-gear so that a transmission ratio is created.

3. The electromechanical drum brake according to claim 2, wherein the actuating rack is fork-shaped in a region of the coupling gear and each portion of the fork-shaped actuating rack is in engagement with a gear ring having the same number of teeth.

4. The electromechanical drum brake according to claim 1, wherein the push rod has a joint which permits movements of the push rod orthogonal to an axis of the coupling gear and orthogonal to a longitudinal extension of the push rod.

5. The electromechanical drum brake according to claim 1, wherein the drive unit is driven in a torque-controlled manner.

6. The electromechanical drum brake according to claim 1, wherein the rack is driven via a drive pinion that has a smaller diameter than the coupling gear.

7. The electromechanical drum brake according to claim 1, wherein the actuating rack is configured to apply a force to the second brake shoe at a level of an axis of the coupling gear.

8. A motor vehicle, comprising:
an electromechanical drum brake including:
a drum, in which brake shoes are disposed, and
an adjusting device, which is disposed between the brake shoes and driven by a drive unit using which the brake shoes can be spread apart for braking, the adjusting device including a rack which is driven by the drive unit, is floatingly mounted between the brake shoes, and is in engagement with a coupling gear that acts on a first brake shoe of the brake shoes via a push rod connected to it, wherein an actuating rack which acts on a second brake shoe of the brake shoes is in engagement with the coupling gear on a side of the coupling gear opposite to the rack, and the coupling gear can move freely on the rack between the brake shoes so that force differences that occur between the brake shoes can be compensated by rotating the coupling gear.
